(19) United States
(12) Patent Application Publication
(10) Pub. No.: US 2006/0285431 A1
(43) Pub. Date: Dec. 21, 2006

(54) Jet device for mixing fluid

(75) Inventors: Jie Wu, Victoria (AU); Lachfan Graham, Victoria (AU); Tony Kilpatrick, Victoria (AU)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Commonwealth Scientific And Industrial Research Organisation

(21) Appl. No.: 10/561,782

(22) PCT Filed: Jun. 15, 2004
(86) PCT No.: PCT/AU04/00786

§ 371 Date: Dec. 19, 2005

(30) Foreign Application Priority Data
Jun. 19, 2003 (AU) 2003903192

(51) Int. Cl. B01F 15/00; B05B 17/04

(52) U.S. Cl. 366/167.2; 366/169.1; 239/11

(57) ABSTRACT

A jet device (1) with an outlet (4) having a nozzle (6) arranged to rotate as fluid exits the device, wherein the nozzle is adapted to feed fluid into a tank and cause mixing of the contents of the tank as a result of fluid flow from the rotating nozzle. Preferably, the device has a control assembly (15) for controlling rotation of the nozzle.

### FIELD OF THE INVENTION

The present invention relates to a jet device particularly, but not exclusively, for mixing mono- or multi-phase fluid or a suspension in a large scale industrial tank or pool.

### BACKGROUND OF THE INVENTION

Large-scale industrial liquid and suspension tanks often experience poor flow circulation and sediment building up on a bottom of the tank. Poor mixing can cause material variation in fluid fed to downstream processing units.

Settling of particles can also lead to reduction in tank operating capacity and increased maintenance cost. For example, build-up of sludge sediment in crude oil tanks at oil refineries reduces effective tank working volume. Cleaning sludge sediment in these tanks is time consuming and labour intensive work. The tank down-time, direct cleaning and handling of sludge for disposal are significant costs to an oil refinery.

In the water industry, fine silt particles in a drinking water system build up in water storage tanks over time. Poor mixing in the tank leads to waste of chlorine dosed into the tanks. This leads to poor water quality for customers, and increased operating cost in tank cleaning and chlorine consumption.

### SUMMARY OF THE INVENTION

In accordance with the invention, there is provided a jet device with an outlet having a nozzle arranged to rotate as fluid exits the device, wherein the nozzle is adapted to feed fluid into a tank and cause mixing of the contents of the tank as a result of fluid flow from the rotating nozzle.

Preferably, the device has a control assembly for controlling rotation of the nozzle.

In one form, the control assembly includes an hydraulic motor operatively coupled to the nozzle. Preferably, the hydraulic motor includes a turbine arranged to be driven by a secondary jet flow. The hydraulic motor may include a conduit for delivering the jet flow to the turbine. In one example, the conduit is arranged to divert fluid flowing through the device onto the turbine. More preferably, the turbine is in the form of a paddle assembly.

Preferably, the nozzle is adapted to rotate under action of flow momentum, resulting from fluid flow through the device. The nozzle is preferably laterally offset relative to a main housing of the device.

With that configuration, the control assembly functions as a speed governor and includes a paddle assembly operatively coupled to rotate under action of the rotating nozzle.

In either case, the control assembly is preferably connected to a gear box which is in turn coupled to the output via a shaft extending substantially coaxially with respect to the output.

### BRIEF DESCRIPTION OF THE DRAWINGS

The invention is described, by way of non-limiting example only, with reference to the drawings, in which:

FIG. 1 is a partially-sectioned perspective view of a jet device;

FIG. 2 is a plan view of the device; and

FIG. 3 is a partially-sectioned perspective view of another jet device.

### DETAILED DESCRIPTION

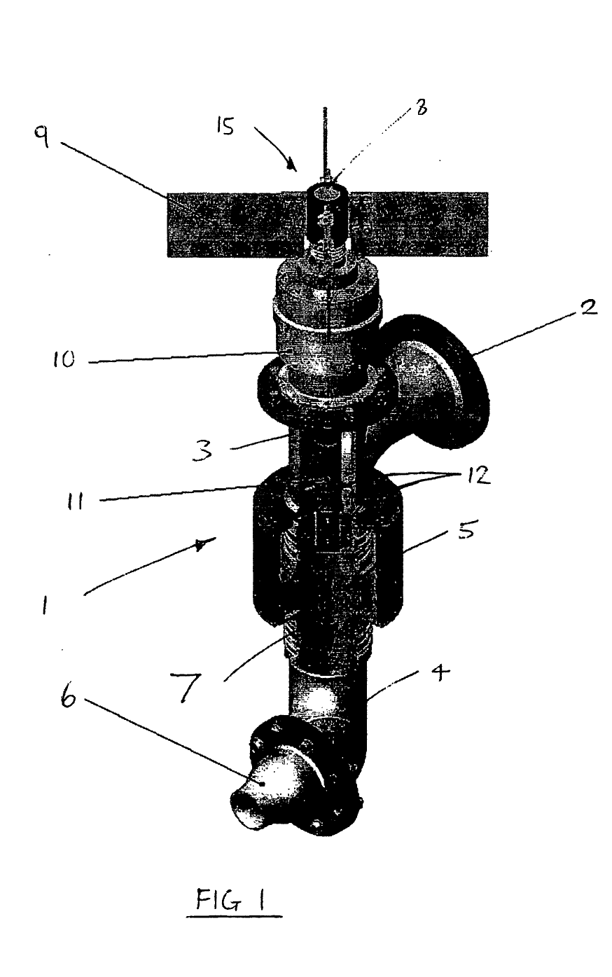

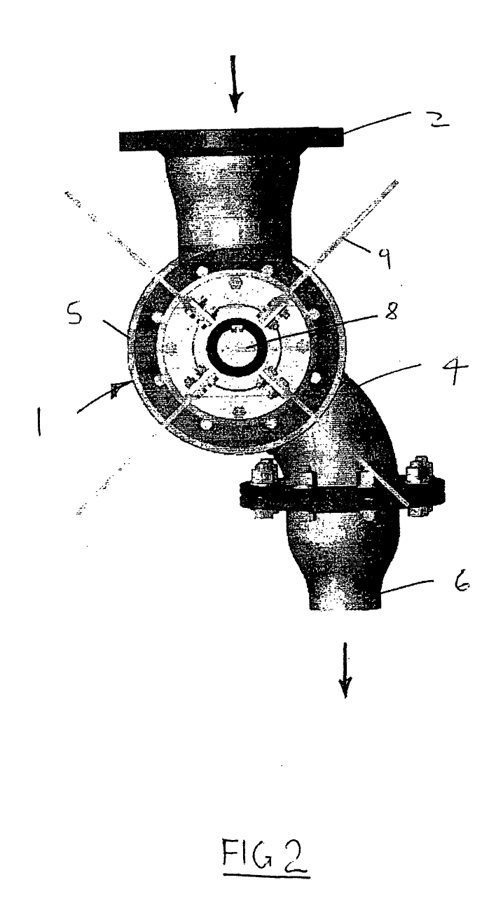

Referring firstly to FIGS. 1 and 2, a rotating jet device 1 includes an inlet 2 coupled to a main housing 3 for fluid communication with an outlet 4. The outlet 4 is mounted in a bearing 5 for rotation relative to the main housing 3. The outlet 4 includes a nozzle 6 which is laterally offset relative to the main housing 3 and, in particular, arranged laterally with respect to a flow path, indicated by arrow 7, which passes from the inlet 2, through the housing 3, to the outlet 4. The change in flow momentum, of fluid exiting the nozzle 6 in an offset direction produces a torque which causes the nozzle 6 to rotate relative to the housing 3 in a counter-clockwise direction, when viewed in FIG. 2.

The inlet 2 of the device may be connected to an end of a feed pipe (not shown) so that pressurised fluid from the feed pipe is jetted out of the nozzle 6 and into surrounding fluid in a tank, or the like, in a rotational manner.

Rapid rotation of the nozzle 6 may not be particularly beneficial for mixing purposes and a control assembly 15, which functions as a speed governor 8 is provided to dampen the rotational speed of the nozzle 6. The governor 8 includes a paddle assembly 9 which is coupled to the outlet 4 via a gearbox 10 and a drive shaft 11 which is connected, via webs 12, substantially coaxially with respect to the outlet 4. Rotation of the outlet 4 and nozzle 6 thereby causes rotation of the drive shaft 11 which translates into a higher speed rotation of the paddle assembly 9. The paddle assembly 9 will experience flow resistance when the device is submerged in a tank and that flow resistance will govern the speed of rotation of the nozzle 6, to improve mixing.

Since the jet device 1 expels fluid via the rotating nozzle, the effective mixing of the device 1 is substantially increased as compared to a stationary-type inlet nozzle. Further, the speed of rotation is automatically governed by the paddle assembly 9 so that only slow rotation of the nozzle 6 occurs, to help maximise mixing efficiency. Also, because the rotation of the nozzle 6, and thereby the governor 8, is effected via flow momentum, from fluid passing through the device 1, no electrical power is required to drive the device. Accordingly, the device 1 is safe for use in mixing flammable liquids such as, for example, crude oil.

As such, the device may be installed in crude oil tanks which may typically be 60 to 70 m in diameter and 16 m in height. However, the device also has application to water storage tanks or any other suitable chemical, food, beverage or industrial waste-treatment tanks or pools, to improve mixing and to keep particulate matter in suspension during use, to thereby remove the requirement for tank off-line cleaning and the need to handle sediment or sludge which may result from improper mixing within the tank.

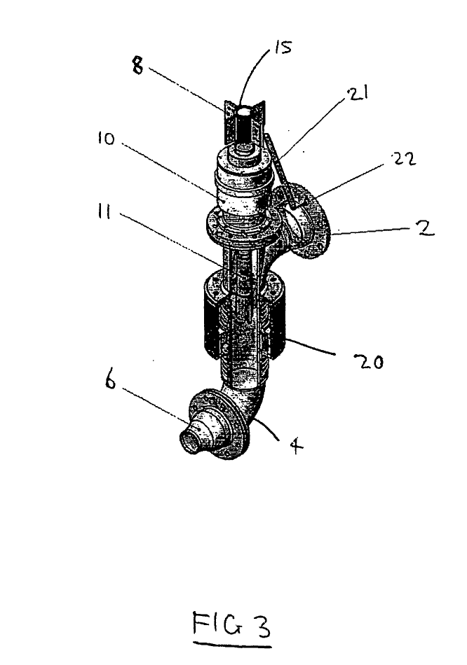

Another jet device 20 is shown in FIG. 3. The device 20 is generally similar to that shown in FIGS. 1 and 2, and like parts are denoted with like reference numerals. The control assembly 15 in this instance, however, operates to drive the outlet 4 and nozzle 6 and, for that purpose, functions as an hydraulic motor, in which the paddle assembly 8 forms a turbine driven by a secondary jet of fluid which is made incident on the paddle assembly via a conduit 21.

The conduit 21 is coupled into the device 20 adjacent the inlet 2 so as to divert fluid flowing through the device 20 onto the paddle assembly 8. A self-cleaning filter 22 is provided to prevent coarse particles entering the conduit 21. The conduit may instead be connected to an alternative source of fluid flow (not shown), for example, an external pump equipped with a variable speed motor controller or other means of varying the flow rate to the conduit 21, such as a throttling valve.

The ability to drive the outlet 4 from the control assembly 15 provides an advantage in allowing the nozzle to be rotated in circumstances where proper operation of the jet device 1 would otherwise be impeded such as where the nozzle 6 is buried in sediment that has settled from a suspended state within a tank, during a period of non-use of the device.

Since the outlet 4 is driven by the control assembly 15, the nozzle 6 need no longer be laterally offset relative to the main housing 3 and that may serve to simplify construction to some degree. The dimensions of the paddles may also be reduced, as compared to the arrangement shown in FIGS. 1 and 2 which may allow the device 20 to be more easily installed through a service hole in a tank. The reduced size of the paddles results from the principle function of the paddle assembly 8 being to drive the outlet 4 at a predetermined speed, as opposed to providing flow resistance, as is required in the device 1. The paddles may, however, still provide a limited speed governing function due to flow resistance encountered during rotation and nevertheless need to be of sufficient size to allow relatively high torque to be transferred to the nozzle 6 particularly in situations where the nozzle encounters drag due to settled solids.

As with the device of FIGS. 1 and 2, the device 20 also has the advantage of the nozzle 6 being driven by fluid flow instead of electrical motors or the like, and that provides for greater safety in situations where the device is used with flammable liquids.

The device has been described by way of non-limiting example only and many modifications and variations may be made thereto without departing from the spirit and scope of the invention as described.

1. A jet device with an outlet having a nozzle arranged to rotate as fluid exits the device, the nozzle being adapted to feed fluid into a tank and cause mixing of the contents of the tank as a result of fluid flow from the rotating nozzle, including:
a control assembly for controlling rotation of the nozzle, wherein
the control assembly includes an hydraulic motor operatively coupled to the nozzle and arranged to be driven by a secondary jet flow.

2. A jet device as claimed in claim 1, wherein the hydraulic motor includes a paddle assembly which is driven by the secondary jet flow.

3. A jet device as claimed in claim 2, wherein the control assembly includes a conduit for delivering the jet flow to the paddle assembly.

4. A jet device as claimed in claim 3, wherein the conduit is arranged to divert fluid flowing through the device onto the paddle assembly.

5. A jet device as claimed in claim 1, wherein the control assembly functions as a speed governor.

6. A jet device as claimed in claim 1, wherein the paddle assembly is connected to a gear box which is in turn coupled to the output.

7. A jet device with an outlet having a nozzle arranged to rotate as fluid exits the device, the nozzle being adapted to feed fluid into a tank and cause mixing of the contents of the tank as a result of fluid flow from the rotating nozzle, including:
a control assembly for controlling rotation of the nozzle, wherein
the control assembly includes a paddle assembly connected to the output via a gear.

8. A jet device as claimed in claim 6 or 7, wherein the gear is coupled to the output via a shaft extending substantially coaxially with respect to the output.

9. A jet device as claimed in claim 6 or 7, wherein the gear allows the speed of rotation of the nozzle to be determined based on flow resistance experienced by the paddle assembly.

10. A jet device as claimed in claim 1 or 7, wherein the nozzle is adapted to rotate under action of flow momentum, resulting from fluid flow through the device.

11. A jet device as claimed in claim 1 or 7, wherein the nozzle is laterally offset relative to a main housing of the device.

12. A jet device as claimed in claim 1 or 7, wherein the device is dimensioned to pass through a service hole in the tank.

13. A method of fitting a jet device, as claimed in claim 1 or 7, in a tank, including passing the device through a service hole in the tank.
